(19) United States
(12) Patent Application Publication
(10) Pub. No.: US 2025/0385757 A1
(43) Pub. Date: Dec. 18, 2025

(54) TECHNOLOGIES FOR POLL RETRANSMIT TIMERS

(71) Applicant: Apple Inc., Cupertino, CA (US)

(72) Inventors: Ping-Heng Kuo, London (GB); Haijing Hu, Los Gatos, CA (US); Ralf Rossbach, Munich (DE)

(73) Assignee: Apple Inc., Cupertino, CA (US)

(21) Appl. No.: 19/204,349

(22) Filed: May 9, 2025

Related U.S. Application Data
(60) Provisional application No. 63/659,274, filed on Jun. 12, 2024.

(51) Int. Cl. H04L 1/08

(52) U.S. Cl. CPC H04L 1/08

(57) ABSTRACT

The present application relates to devices and components including apparatus, systems, and methods for adaptive selection or control of a poll retransmit timer or timer value.

### CROSS-REFERENCE TO RELATED APPLICATION

This application claims the benefit of U.S. Provisional Patent Application No. 63/659,274, filed on Jun. 12, 2024, which is herein incorporated by reference in its entirety for all purposes.

### TECHNICAL FIELD

This application relates generally to communication networks and, in particular, to technologies for poll retransmit timers in wireless networks.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates aspects of a user equipment in accordance with some embodiments.

FIG. 3 illustrates operational/signaling aspects in accordance with some embodiments.

FIG. 4 illustrates operation of a radio link control layer in accordance with some embodiments.

FIG. 5 illustrates an operational flow/algorithmic structure in accordance with some embodiments.

FIG. 6 illustrates another operational flow/algorithmic structure in accordance with some embodiments.

FIG. 7 illustrates another operational flow/algorithmic structure in accordance with some embodiments.

FIG. 8 illustrates a user equipment in accordance with some embodiments.

FIG. 9 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

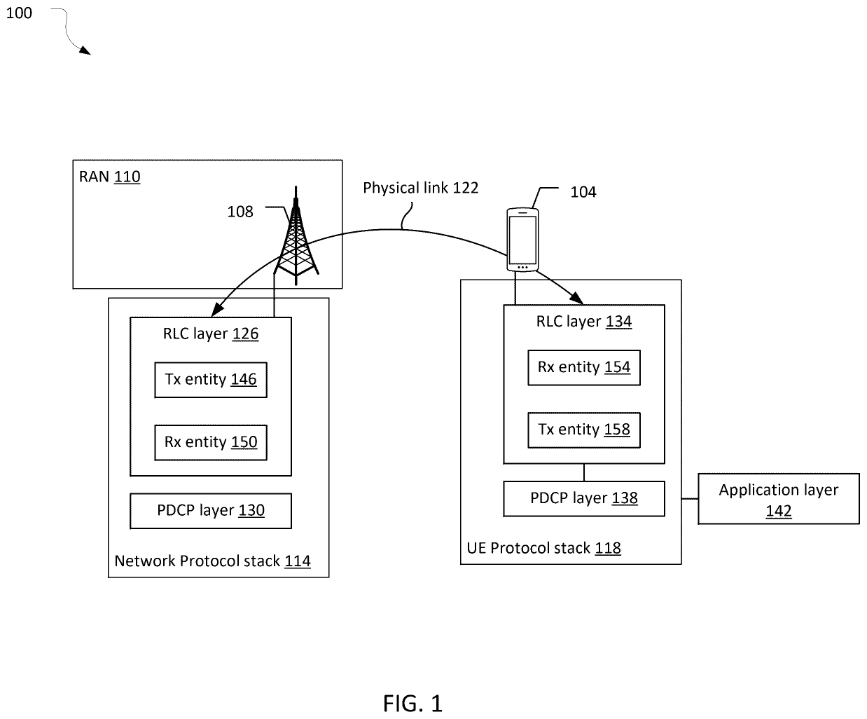

FIG. 1 illustrates a network environment 100 in accordance with some embodiments. The network environment 100 may include user equipment (UE) 104 communicatively coupled with base station 108 of a radio access network (RAN) 110. The UE 104 and the base station 108 may communicate over air interfaces compatible with 3GPP TSs, such as those that define a Fifth Generation (5G) new radio (NR) system or a later system. The base station 108 may provide user plane and control plane protocol terminations toward the UE 104.

The 3GPP TSs may define operations of protocol stacks, e.g., network protocol stack 114 or UE protocol stack 118. The protocol stacks may implement a set of communication protocols. In some examples, the protocol stack may be designed in a layered architecture for modularity, with each layer providing specific functions. The design may allow changes in one layer without affecting others, which may facilitate upgrades and improvements. The layers may include a physical layer (Layer 1 (L1) or PHY) responsible for establishing and maintaining a physical link 122. Control signaling and data may be sent over the air interface and the physical link 122. The network protocol stack 114 may include a data link layer (Layer 2 (L2)) that may be divided into sublayers such as a medium access control (MAC) layer, a radio link control (RLC) layer 126, and a packet data convergence protocol (PDCP) layer 130. The UE protocol stack 118 may also include a data link layer with a MAC layer, an RLC layer 134, and a PDCP layer 138. Layer 2 may be responsible for managing the UE 104 connectivity and movement between cells and networks. An application layer 142 may sit above UE protocol stack 118.

The RLC layers may be responsible for reliable data transmission. The RLC layer 126 may include a transmitting (Tx) entity 146 and a receiving (Rx) entity 150, and the RLC layer 134 may include a Rx entity 154 and an Tx entity 158. The Tx entities may segment data from higher layers, e.g., PDCP or application layer, and add sequence numbers and headers. These packets may then be transmitted over the air interface, e.g., via the physical link 120. At the receiver end, the Rx entities may reassemble the packets back into the original data, e.g., using the sequence numbers and header information to ensure correct order and to detect any missing packets. If a packet is detected as missing or erroneous, the Rx entity can request retransmission from the Tx entity.

In the downlink transmission, the base station 108 is the transmitting end, and the UE 104 is the receiving end. The Tx entity 146 sends the packets via the physical link 120 to the Rx entity 154, which receives and reassembles the packets. The Rx entity 150 may be called a peer entity to the Tx entity 158, and the Tx entity 146 may be called a peer entity to the Rx entity 154.

In some embodiments, the packet transmitted by a Tx entity may be referred to as an RLC protocol data unit (PDU). In some instances, a packet received by a layer from higher layers is called the service data unit (SDU) of that layer. The packet transmitted by the layer to lower layers is called the PDU of that layer. For example, packets received by an RLC layer from a PDCP layer are called RLC SDUs, and packets sent by an RLC layer to a MAC layer are called RLC PDUs.

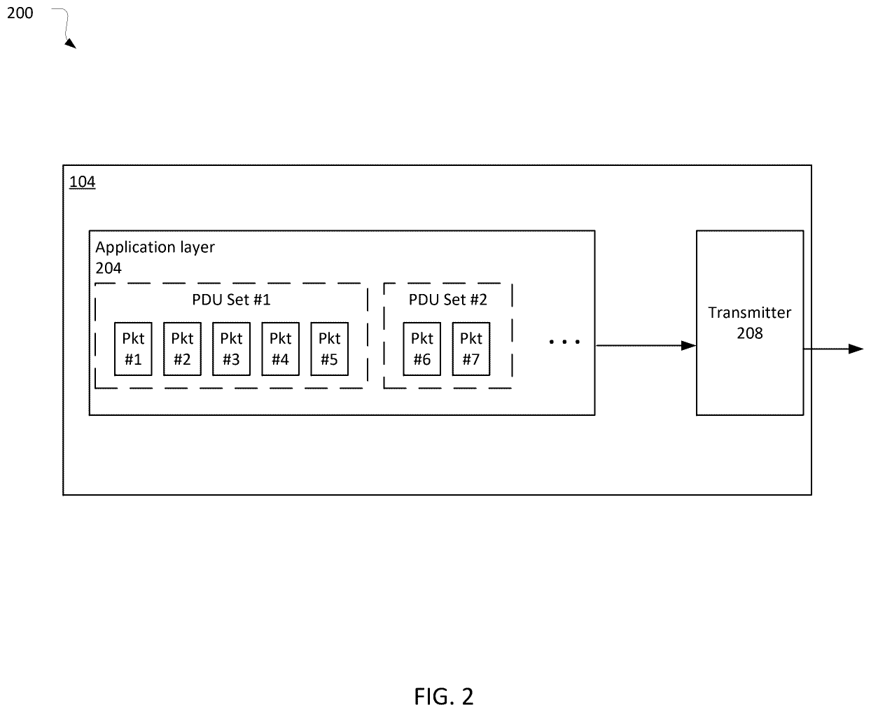

FIG. 2 illustrates aspects of the UE 104 in further detail in accordance with some embodiments. The UE 104 may include the application layer 142 that generates application traffic to be transmitted to another device through the network environment 100. In some embodiments, the application layer 142 may have an extended reality (XR) application that generates XR traffic. However, embodiments are not limited to XR use cases.

For XR and other services, the application layer 142 may generate PDU sets, with individual PDU sets comprising one or more packets. A packet, which may also be referred to as a PDU, may be an Internet protocol (IP) packet or a non-IP packet. As shown, PDU set #1 may include packets #1-#5, while PDU set #2 includes packets #6 and #7. Each PDU set may be mapped to a different quality of service (QOS) flow. Different PDU sets may be mapped to different traffic flows when they correspond to different traffic flows or modalities.

The packets of a PDU set may carry a payload of one unit of information generated by the application layer 142. The unit of information may be a frame or video slice for XR Services, such as those defined in 3GPP TS 23.501 v18.5.0 (2024-03-27), for example.

In some embodiments, a PDU Set QoS Parameter may be defined. This parameter may be referred to as PDU Set Integrity Handling Indication (PSIHI) that is used to indicate whether an application layer needs every PDU of a PDU Set. If the PSIHI indicates the application layer needs every PDU of a PDU set, the data radio bearer (DRB) may be configured to discard the whole PDU Set when at least one PDU of this PDU Set is lost/discarded. This behavior may be configured by a PDU-set discard radio resource control (RRC) parameter (pdu-SetDiscard).

Each PDU set may be associated with the following information: a PDU set sequence number (SN); an indication of an end PDU of the PDU Set; a PDU SN within a PDU Set; PDU Set size in bytes; and a PDU Set Importance (PSI). The PSI may be used to identify the relative importance of a PDU Set compared to other PDU Sets within the same QoS Flow.

In some embodiments, the PSI may be used as a basis for discarding. For example, the network may use a dynamic mechanism (based on a MAC control element (CE), for example) where a base station may instruct a UE to apply different discard timers for PDU sets with different PSIs on an uplink DRB. For example, a shorter discard timer may be set for less important PDU sets.

The PDU sets may be provided to a transmitter 208 of the UE 104. The transmitter 208 may be configured to execute a communication protocol stack, for example, UE protocol stack 118 of FIG. 1, to facilitate communication via the network environment 100. The transmitter 208 may implement L2 and L1 functionality. At the L2 level, transmitter 208 may include a service data adaptation protocol (SDAP) layer, a PDCP layer, an RLC layer, and a MAC layer. At the L1 level, the transmitter 208 may include a physical (PHY) layer. Briefly, the SDAP layer may manage QoS flow handling between the QoS flows and the DRBs. The PDCP layer may manage robust header (de) compression and security between DRBs and RLC channels. The RLC layer may manage (re-)segmentation and error correction through automatic repeat requests (ARQ) between logical channels and RLC channels. The MAC layer may manage scheduling/priority handling, (de)multiplexing, and hybrid automatic repeat request (HARQ) processes between logical channels and transport channels. The PHY layer may manage the processing of the physical data and control channels.

In some embodiments, in order to assist delay-aware scheduling for XR or other traffic, delay status reporting (DSR) may be used.

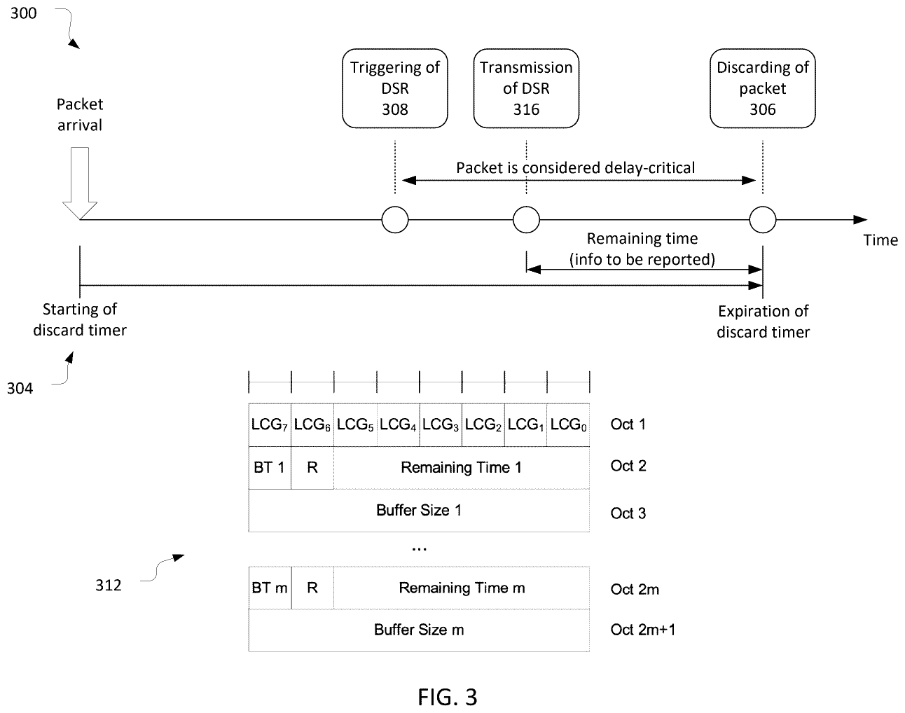

FIG. 3 illustrates operational/signaling aspects 300 related to DSR in accordance with some embodiments. In some embodiments, the operational/signaling aspects 300 may be implemented by a MAC layer of the transmitter 208.

The operational/signaling aspects 300 may include starting a discard timer when a packet arrives at 304. The packet may include data of a logical channel (LCH). The discard timer may define the time by which the packet is required to be transmitted. If the packet is not transmitted when the discard timer expires, the packet may be discarded at 306.

At 308, a DSR may be triggered based on the remaining time until expiry of the discard timer satisfying a remaining time threshold. At a trigger of the DSR, the MAC layer may generate a DSR MAC CE 312 that includes buffer delay information. The buffer delay information may include a remaining time till discard timer expiry. This remaining time may be with reference to transmission of the DSR at 316 (for example, start of an uplink shared channel used to transmit the DSR MAC CE 312). The buffer delay information may additionally include information related to a data volume (for example, a size of a buffer) account for the remaining time.

Referring again to FIG. 1, control signaling from the base station 108 may provide an uplink grant to the UE 104. When the MAC layer receives the uplink grant, it may generate a MAC PDU for the uplink grant via a logical channel prioritization (LCP) procedure. This may be done by multiplexing data from different LCHs into the same transport block. This procedure may be based on preconfigured parameters for each LCH (for example, priority, prioritized bit rate, and LCH mapping restrictions). These preconfigured parameters determine, for example, the ordering of multiplexing among the LCHs, the amount of data from an LCH to be multiplexed, and whether an LCH is allowed to map to this uplink grant. Except as otherwise described herein, the MAC PDU may be generated in a manner similar to that described in 3GPP TS 38.321 v18.1.0 (2024-04-04).

In later releases, the LCP procedure may be conducted based on the buffer delay information (for example, the remaining time till expiry of a discard timer).

In some instances, a priority of an LCH (or other pre-configured parameter) may change based on a remaining time of packets buffered in this LCH. For example, the LCH priority may increase when the remaining time of packets buffered in this LCH drops below a threshold.

In some instances, a new type of UL grant may be introduced, in which delay-critical data should be selected/prioritized during the LCP procedure. Consider, for example, that a MAC layer is generating a MAC PDU from buffered data from two LCHs (e.g., LCH #1 and LCH #2). If the UL grant indicates that the delay-critical data should be selected/prioritized, the MAC layer may generate the MAC PDU to include delay-critical data from the LCHs and may exclude data from the LCHs that is not considered delay critical.

The definitions of delay-critical packets have been introduced in Release 18 PDCP and RLC specifications. A delay-critical packet may refer to a packet whose remaining time is smaller than a threshold or to other packets that belong to a same PDU Set as a packet whose remaining time is smaller than a threshold. For example, with respect to PDCP packets, delay-critical packets are defined as follow: “Delay-critical PDCP SDU: if pdu-SetDiscard is not configured, a PDCP SDU for which the remaining time till discardTimer expiry is less than the remaining TimeThreshold. If pdu-SetDiscard is configured, a PDCP SDU belonging to a PDU Set of which at least one PDCP SDU has the remaining time till discardTimer expiry less than the remainingTimeThreshold.” 3GPP TS 38.323 v18.1.0 (2024-04-02).

The introduction of the delay-critical PDCP SDU in TS 38.323 may allow for calculation of buffer size for the DSR MAC CE. “For the purpose of MAC delay status reporting, the transmitting PDCP entity shall consider the following as delay-critical PDCP data volume: —the delay-critical PDCP SDUs for which no PDCP Data PDUs have been constructed; —the PDCP Data PDUs that contain the delay-critical PDCP SDUs and have not been submitted to lower layers; —the PDCP Control PDUs; —for AM DRBs, the PDCP SDUs to be retransmitted according to clause 5.1.2 and clause 5.13; —for AM DRBs, the PDCP Data PDUs to be retransmitted according to clause 5.5. If a PDCP SDU becomes a delay-critical PDCP SDU, and if the corresponding PDCP Data PDU has already been submitted to lower layers, the delay-critical indication for the PDCP Data PDU is provided to lower layers.” TS 38.323, Section 5.15 Data volume calculation for delay status reporting.

A delay-critical RLC SDU may be defined in 3GPP TS 38.322 v18.0.0 (2024-01-13) as “an RLC corresponding to a PDCP PDU indicated as delay-critical by PDCP.” TS 38.322 goes on to provide RLC data volume calculation. For the purpose of MAC delay status reporting, the UE shall consider the following as delay-critical RLC data volume: —delay-critical RLC SDUs and delay-critical RLC SDU segments that have not yet been included in an RLC data PDU; —RLC data PDUs pending for initial transmission, and containing a delay-critical RLC SDU or a delay-critical RLC SDU segment; —RLC data PDUs that are pending for retransmission (RLC AM). In addition, if a STATUS PDU has been triggered and t-StatusProhibit is not running or has expired, the UE shall estimate the size of the STATUS PDU that will be transmitted in the next transmission opportunity, and consider this as part of RLC data volume for MAC buffer status reporting and as part of delay-critical RLC data volume for MAC delay status reporting.” TS 38.322, Section 5.5 Data volume calculation.

XR enhancements for Release 19 may specify aspects related to multi-modality (intra-UE). This may facilitate efficient and effective support for XR applications with multiple QoS flows with multi-modal inter-dependencies, and meet multi-modal QoS requirements, e.g. synchronization and/or coordination. Efficiency enhancements may be expected to be visible in terms of capacity or power consumption.

XR enhancements may also enable transmission/reception in gaps/restrictions that are caused by radio resource management (RRM) measurements (from inter-frequency RRM measurement gaps, intrafrequency measurements, or other scheduling restrictions, etc.)

XR enhancements may also specify corresponding measurement gap and scheduling restrictions to enable identified enhancements with RRM performance impact taken into consideration.

XR enhancements may also specify various scheduling enhancements. For example, for uplink, enhancements related to use of delay/deadline information may support uplink scheduling to enable high XR capacity while meeting delay requirements/avoiding too late PDUs. LCP implementation complexity may be taken into account when evaluating various approaches.

XR enhancements may also specify user plane enhancements. For example, RLC retransmission related enhancements may be defined for operation of Acknowledged Mode (AM) RLC with small packet delay budget. Furthermore, mechanisms for a transmitter to inform a receiver of SN gap (or missing SNs) in PDCP may be defined if needed.

In AM RLC, each transmitted PDU is assigned a sequence number. The receiver may send acknowledgments (ACKs) for correctly received PDUs and negative acknowledgments (NACKs) for missing or erroneous PDUs. Upon receiving a NACK, or in the absence of an ACK associated with a PDU, the transmitter may retransmit the corresponding PDU.

In some embodiments, when RLC PDUs are delivered to lower layers for transmissions, a copy of the corresponding RLC SDU may be buffered for retransmission. The RLC SDU may remain in the retransmission buffer until the receiver side of the RLC receives an ACK or a NACK associated with the RLC SDU. If an ACK is received, the RLC SDU is removed from the retransmission buffer. However, if a NACK is received, the transmitting side of the RLC may retransmit the RLC SDU. In some instances, the RLC SDUs in the retransmission buffer may stall or prevent the initial transmission of new RLC SDUs due to restrictions imposed by a transmitting window.

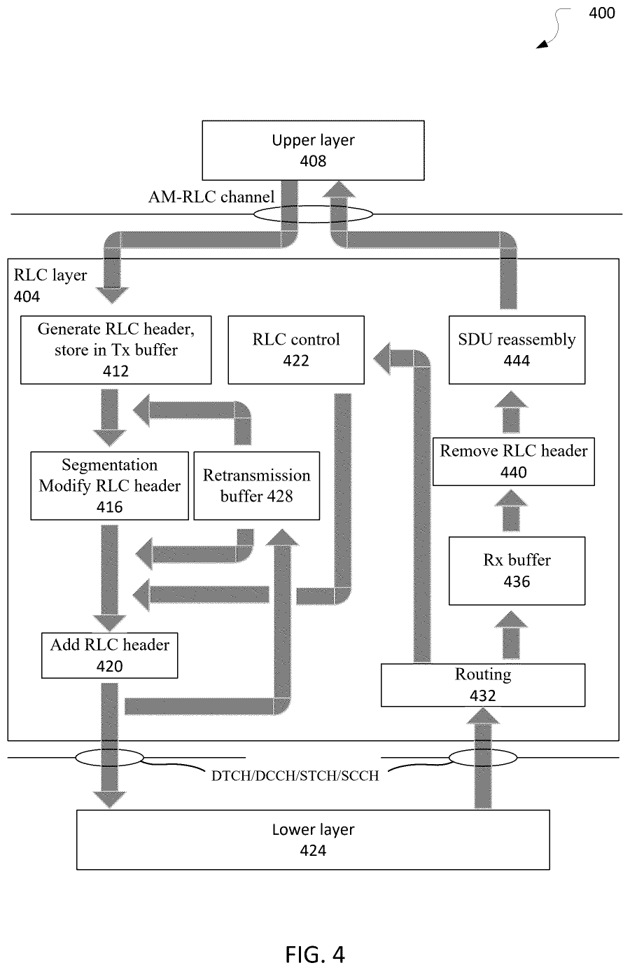

FIG. 4 illustrates operation of an RLC layer 404 in accordance with some embodiments. The RLC layer 404 may correspond to RLC layer 126 or RLC layer 134 in various embodiments.

In the downlink, the RLC layer 404 may receive a packet from an upper layer 408. The upper layer may be, for example, a PDCP layer. The packet may be received via an AM-RLC channel. The RLC layer may generate an RLC header and store the packet with the RLC header in a transmission buffer at 412. The RLC layer 404 may then perform the segmentation and modify the RLC header that 416. At 420, the RLC header may be added to the packet to generate an acknowledged mode data (AMD) PDU. This may be based on control signals provided by RLC control 422. The AMD PDU may be provided to a lower layer 424 for transmission. The AMD PDU may be provided to the lower layer 424 via a logical channel such as: dedicated control channel (DCCH), dedicated traffic channel (DTCH), sidelink control channel (SCCH), or sidelink traffic channel (STCH). The AMD PDU may also be stored in a retransmission buffer at 428.

In the uplink, the lower layer for 24 may provide a packet to the RLC layer via DTCH/DCCH/STCH/SCCH. The RLC layer 404 may perform routing at 432. Feedback may be provided to the RLC control 422; and uplink data may be sent to the Rx buffer 436. The RLC layer 404 may remove RLC headers from buffered packets at 440 and perform an SDU reassembly at 444. The reassembled SDUs may be provided to the upper layer 408 via the AM-RLC channel.

The transmitting side of an AM RLC entity may maintain a transmitting window, and may not submit to a lower layer any AMD PDU whose SN falls outside of the transmitting window. An SN may be within the transmitting window if TX_Next_Ack<=SN<TX_Next_Ack+AM_Window_Size; otherwise, the SN may be outside the transmitting window. TX_Next is a state variable that holds a value of the SN to be assigned for the next newly generated AMD PDU; TX_Next_Ack is a state variable that holds the value of the SN of the next RLC SDU for which a positive acknowledgment is to be received in-sequence, and it serves as the lower edge of the transmitting window; and AM_Window_Size is a constant number of SNs within the transmitting window. In some embodiments, the AM_Window_Size may be equal to 2048 when a 12-bit SN is used or 131,072 when an 18-bit SN is used.

According to TS 38.322, a new RLC SDU with an SN outside the transmitting window cannot be transmitted. Therefore, it is desirable for the transmitting window to move forward as quickly as possible, so subsequent new packets are less likely to be delayed by window stalling. Moving the transmitting window requires the Tx entity to receive ACK for packets with SNs equal to TX_Next_Ack.

In some embodiments, to expedite moving PDUs out of the retransmission buffer, the transmitter may proactively request ACK/NACKs (STATUS PDU) from the receiver by using a polling mechanism. For example, a Tx entity may poll its peer Rx entity to determine whether transmitted RLC PDUs were properly received. The polling may request transmission of a status report carrying the ACKs or NACKs associated with the RLC PDUs transmitted by the Tx entity.

Polling can be triggered: if the number of AMD PDUs sent since the most recent poll bit was transmitted (tracked by counter PDU_WITHOUT_POLL) is equal or larger than pollPDU; if total bytes of the AMD PDUs sent since the most recent poll bit was transmitted (tracked by counter BYTE_WITHOUT_POLL) is equal or larger than pollBYTE; if both the transmission buffer and the retransmission buffer become empty (excluding transmitted RLC SDUs or RLC SDU segments awaiting acknowledgements) after the transmission of the AMD PDU; if no new RLC SDU can be transmitted after the transmission of the AMD PDU (e.g., due to window stalling); or if a poll retransmit timer (t-PollRetransmit) is expired. The pollPDU may be a parameter (e.g., an integer) used by a transmitting side of each AM RLC entity to trigger a poll for every pollPDU PDUs. The pollByte may be a parameter (e.g., volume threshold) used by a transmitting side of each AM RLC entity to trigger a poll every pollByte bytes. The pollPDU and pollByte parameters may be configured by RRC.

When polling is triggered, the RLC AM entity includes a poll (e.g., a polling bit) in the AMD PDU. When the AMD PDU with the poll is submitted to lower for transmission, the AM RLC entity shall start the poll retransmit timer (t-PollRetransmit). Upon expiration of t-PollRetransmit, the transmitting side of an AM RLC entity may autonomously consider some RLC SDU for retransmission if no new RLC SDU can be transmitted. Operation of the RLC at expiry of the t-PollRetransmit may be similar to that described in section 5.3.3.4 of TS 38.322. “Upon expiry of t-PollRetransmit, the transmitting side of an AM RLC entity shall: —if both the transmission buffer and the retransmission buffer are empty (excluding transmitted RLC SDU or RLC SDU segment awaiting acknowledgements); or —if no new RLC SDU or RLC SDU segment can be transmitted (e.g. due to window stalling): —consider the RLC SDU with the highest SN among the RLC SDUs submitted to lower layer for retransmission; or —consider any RLC SDU which has not been positively acknowledged for retransmission[;] —include a poll in an AMD PDU as described in clause 5.3.3.2.” TS 38.322, Section 5.3.3.4 Expiry of t-PollRetransmit.

In order to accelerate RLC AM retransmission, it may be beneficial to move the transmitting window forward as soon as possible when a packet becomes delay-critical. Otherwise, window stalling may happen and subsequent delay-critical packets that are expected to arrive may not be transmitted immediately. Due to the nature of PDU sets associated with, for example, XR traffic, when a packet becomes delay-critical, many other packets belonging to the same PDU Set may also become delay-critical based on definitions in TS 38.323 (especially, when pdu-SetDiscard is configured). While autonomous retransmission may be applied for delay-critical packets; too many blind retransmissions may waste resource and increase congestion. Since autonomous retransmission may be conducted upon expiration of t-PollRetransmit, some embodiments describe configuration of a shorter timer value (for example, 5 milliseconds (ms)) to enable faster and more frequent retransmission. However, when there are no delay-critical packets for retransmission, more frequent retransmission may be unnecessary.

Various embodiments describe retransmission for delay-critical packets upon expiration of t-PollRetransmit that can happen more rapidly, while avoiding unnecessary retransmission that may result in resource wastage and congestion. In particular, some embodiments provide that, when a poll is triggered and transmitted, a transmitting side of the RLC-AM entity may adaptively select a value of the poll retransmit timer (or another timer altogether) based on one or more conditions relating to the triggering events of the poll.

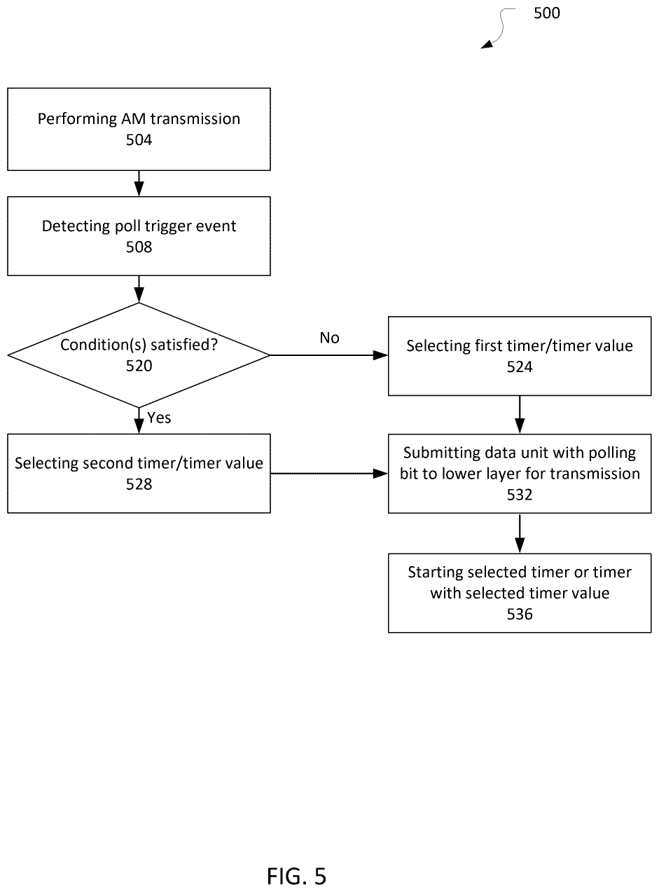

FIG. 5 is an operation flow/algorithmic structure 500 that provides adaptive selection of a timer or timer value in accordance with some embodiments. The operation flow/algorithmic structure 500 may be implemented by a UE such as, for example, UE 104, UE 800, or components thereof; for example, a baseband processor 1004A. In some embodiments, the operation flow/algorithmic structure 500 may be performed by an RLC layer implemented by processing circuitry.

The operation flow/algorithmic structure 500 may include, at 504, performing an AM transmission. Performing the AM transmission may include transmitting AMD PDUs. Upon transmission of the AMD PDUs, copies of the corresponding RLC SDUs may be placed in a retransmission buffer of the RLC (for example, retransmission buffer 428).

The operation flow/algorithmic structure 500 may further include, at 508, detecting a poll trigger event. The poll trigger event may be associated with the AM transmission. The poll trigger event may be when: the number of RLC PDUs sent since the most recent poll bit was transmitted (PDU_WITHOUT_POLL) is equal to or larger than pollPDU; total bytes of the RLC PDUs sent since the most recent poll bit was transmitted (BYTE_WITHOUT_POLL) is equal to or larger than pollBYTE; both the transmission buffer and the retransmission buffer become empty (excluding transmitted RLC SDUs or RLC SDU segments awaiting acknowledgements) after the transmission of the AMD PDU; no new RLC SDU can be transmitted after the transmission of the AMD PDU (e.g., due to window stalling); or a poll retransmit timer (t-PollRetransmit) is expired.

When the poll trigger event is detected at 508, the operation flow/algorithmic structure 500 may advance to determining whether one or more conditions are satisfied at 512. The one or more conditions may be associated with the poll trigger event or buffered packets.

The conditions may include one or more of the following conditions.

A first condition may be determined to be satisfied if at least one RLC SDU arrived/queued in the transmission buffer is considered delay-critical or considered important. The RLC SDU may be considered delay critical if it has a remaining time till expiry of a discard timer less than a remaining time threshold, for example. Alternatively, it may be considered delay critical if it belongs to a PDU set with at least one packet whose remaining time till expiry of a discard timer is less than a remaining time threshold. The RLC SDU may be considered important if it is associated with an importance level greater than a predetermined threshold. In one example, the first condition may be satisfied if a number of delay-critical RLC SDUs or a data amount of delay-critical RLC SDUs in the queue exceeds a threshold. In another example, the first condition may be satisfied if a number of important RLC SDUs or a data amount of important RLC SDUs in the transmission buffer exceeds a threshold.

A second condition may be determined to be satisfied if a number of AMD PDUs corresponding to delay-critical/important RLC SDUs (or segments) sent since the most recent poll bit was transmitted satisfies a threshold. In some embodiments, new parameters such as a counter DELAY_CRITICAL_PDU_WITHOUT_POLL and DelayCriticalPollPDU may be introduced. The DELAY_CRITICAL_PDU_WITHOUT_POLL may be a counter to track a number of AMD PDUs corresponding to delay-critical/important RLC SDUs (or segments) sent since the most recent poll bit was transmitted. The DelayCriticalPollPDU may be an RRC-configured parameter (e.g., an integer) used by a transmitting side of each AM RLC entity to trigger a poll for every DelayCriticalPollPDU PDUs.

A third condition may be determined to be satisfied if a number of bytes of AMD PDUs corresponding to delay-critical/important RLC SDUs (or segments) sent since the most recent poll bit was transmitted satisfies a threshold. In some embodiments, new parameters such as a counter DELAY_CRITICAL_BYTE_WITHOUT_POLL and DelayCriticalPollByte may be introduced. The DELAY_CRITICAL_BYTE_WITHOUT_POLL may be a counter to track bytes of AMD

PDUs corresponding to delay-critical/important RLC SDUs (or segments) sent since the most recent poll bit was transmitted. The DelayCriticalPollByte may be an RRC-configured parameter (e.g., a volume threshold) used by a transmitting side of each AM RLC entity to trigger a poll for every DelayCriticalPollByte bytes.

A fourth condition may be determined to be satisfied if a number of RLC PDUs sent since the last transmission of an RLC PDU corresponding to delay-critical/important RLC SDUs (or segments) satisfies a threshold. For example, the fourth condition may be determined to be satisfied when the SN gap between the latest RLC PDU and the last RLC PDU corresponding to a delay-critical SDU is greater than a predetermined threshold.

A fifth condition may be determined to be satisfied if a number of bytes of RLC PDUs sent since the last transmission of a RLC PDU corresponding to delay-critical/important RLC SDUs (or segments) satisfies a threshold.

The thresholds and parameters associated with the conditions described above may be predefined in, for example, a 3GPP TS or configured by the network.

The conditions described above may be combined in any of a number of manners. In one example, the first condition and the second condition may be combined. In this embodiment, the conditions may be determined to be satisfied when at least one delay-critical RLC SDU arrives in the transmission buffer is considered delay-critical and the number of RLC PDUs corresponding to delay-critical RLC SDUs (or segments) sent since the most recent poll bit was transmitted satisfies a threshold.

In another example, the first condition and the fourth condition may be combined. In this embodiment, the conditions may be determined to be satisfied when at least one delay-critical RLC SDU arrives in the transmission buffer and a number of RLC PDUs sent since the last transmission of an RLC PDU corresponding to delay-critical RLC SDUs (or segments) satisfies a threshold.

If it is determined that the condition(s) are not satisfied at 520, the operation flow/algorithmic structure 500 may advance to selecting a first timer or timer value. If it is determined that the condition(s) are satisfied at 520, the operation flow/algorithmic structure 500 may advance to selecting a second timer or timer value at 528.

In embodiments in which the selection at 524 and 528 is with respect to a timer value, there may be a plurality of timer values that may be selected for a poll retransmit timer. The first timer value may correspond to a default timer value and the second timer value may correspond to a special timer value. The special timer value may be smaller than the default timer value to enable faster retransmissions. While two timer values are discussed herein, other embodiments may include a selection of a timer value from more than two timer values based on various combinations of specific conditions being satisfied.

In some embodiments, the timer value may be selected based on selecting an adjustment parameter that is applied to a default timer value. For example, the adjustment parameter may reduce a t-PollRetransmit timer value by a configurable amount or fraction. In some embodiments, one adjustment parameter may be defined for use when the conditions are satisfied. In other embodiments, one adjustment parameter may be selected from a plurality of adjustment parameters based on specific conditions being satisfied.

In embodiments in which the selection at 524 and 528 is with respect to a timer, there may be a plurality of different timers (e.g., poll retransmit timers) that may be selected. The first timer may correspond to a default timer (e.g., t-PollRetransmit) and the second timer may correspond to a special timer (e.g., t-PollRetransmitDelayCritical). The special timer may be configured with a smaller timer value than the default timer to enable faster retransmissions. While two timers are discussed herein, other embodiments may include a selection from more than two.

The timers/timer values may be preconfigured by a network using, for example, RRC signaling. In some embodiments, the special timer/timer value may be set to a zero value. This may enable immediate consideration of a retransmission after a poll is sent.

After selecting the timer/timer value at 524 or 528, the operation flow/algorithmic structure 500 may advance to submitting a data unit (e.g., an AMD PDU) with a polling bit to a lower layer for transmission at 532.

The operation flow/algorithmic structure 500 may further include, at 536, starting a selected timer or timer with a selected value. The timer may be started based on the submission of the PDU with polling bit to the lower layer. If the timer expires, the transmitting side of an AM RLC entity may autonomously consider some RLC SDU for retransmission if no new RLC SDU can be transmitted as described above with respect to a poll retransmit timer.

In some embodiments, the conditions considered at block 520 may additionally/alternatively be based on attributes/conditions of PDU sets corresponding to concerned delay-critical SDUs. For example, the transmitting side of the RLC AM entity may select the timer or timer value based on one or more of the following PDU set conditions/attributes: PSI, a PDU set size (for example, in bytes), a number of PDUs in a PDU set, or whether an end PDU of the PDU set has arrived in a transmission buffer.

For example, the second timer/timer value may be selected if a delay-critical RLC SDU (in the buffer or already transmitted) considered in any of the conditions discussed above is a packet belonging to an important PDU Set (instead of a less-important PDU Set). Otherwise, the first timer/timer value may be selected.

In some embodiments, the PSI may be taken into account only if the PSI-based discarding mechanism is configured or activated on the corresponding DRB. When the PSI-based discarding mechanism is disabled, the transmitting side of the RLC AM entity may not consider PSI when selecting the timer/timer value.

In another example, the second timer/timer value may be selected if a delay-critical RLC SDU (in the buffer or already transmitted) considered in any of the conditions discussed above is a packet belonging to a PDU Set with a total size (bytes) exceeding a threshold. Otherwise, the first timer/timer value may be selected.

In some embodiments, the determination of whether a packet is considered delay-critical or not may be based on definitions in TS 38.323 and TS 38.322. For example, a packet may be delay-critical if a remaining time of a packet (or the packet in the same PDU Set) till PDCP discard timer expiry is smaller than a remaining time threshold (remainingTimeThreshold). In other embodiments, a packet may be determined to be delay-critical in other manners. For example, a packet may be delay-critical if it has been queued in a buffer for more than a predetermined threshold, or if a remaining time till PDCP discard timer expiry is smaller than another threshold that is different from the remainingTimeThreshold.

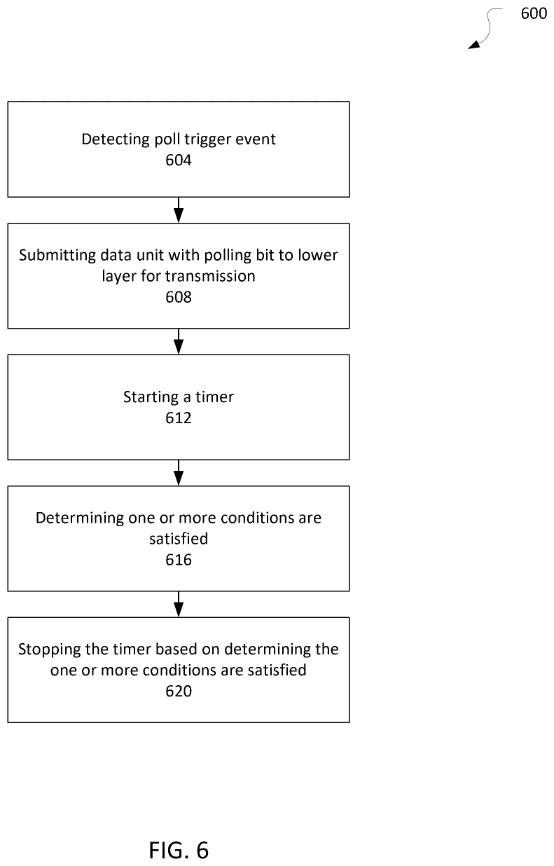

FIG. 6 is an operation flow/algorithmic structure 600 that provides adaptive selection of a timer or timer value in accordance with some embodiments. The operation flow/algorithmic structure 600 may be implemented by a UE such as, for example, UE 104, UE 800, or components thereof; for example, a baseband processor 804A. In some embodiments, the operation flow/algorithmic structure 600 may be performed by an RLC layer implemented by processing circuitry.

The operation flow/algorithmic structure 600 may include, at 604, detecting a poll trigger event. The poll trigger event may be associated with an AM transmission (e.g., transmitted AMD PDUs). This may be similar to poll trigger events discussed elsewhere herein including, for example, block 508 of FIG. 5.

The operation flow/algorithmic structure 600 may further include, at 608, submitting a data unit (e.g., an AMD PDU) with a polling bit to a lower layer for transmission.

The operation flow/algorithmic structure 600 may further include, at 612, starting a timer. The timer may be a default poll retransmit timer.

The operation flow/algorithmic structure 600 may further include, at 616, determining one or more conditions are satisfied. The one or more conditions may be similar to conditions described elsewhere herein including, for example, conditions/attributes discussed with respect to FIG. 5.

The operation flow/algorithmic structure 600 may further include, at 620, stopping the timer based on determining the one or more conditions are satisfied. Thus, in this embodiment, the transmitter can directly consider the poll retransmit timer as expired when certain, predefined conditions are satisfied. This may enable faster retransmissions in a manner similar to that discussed above with respect to FIG. 5.

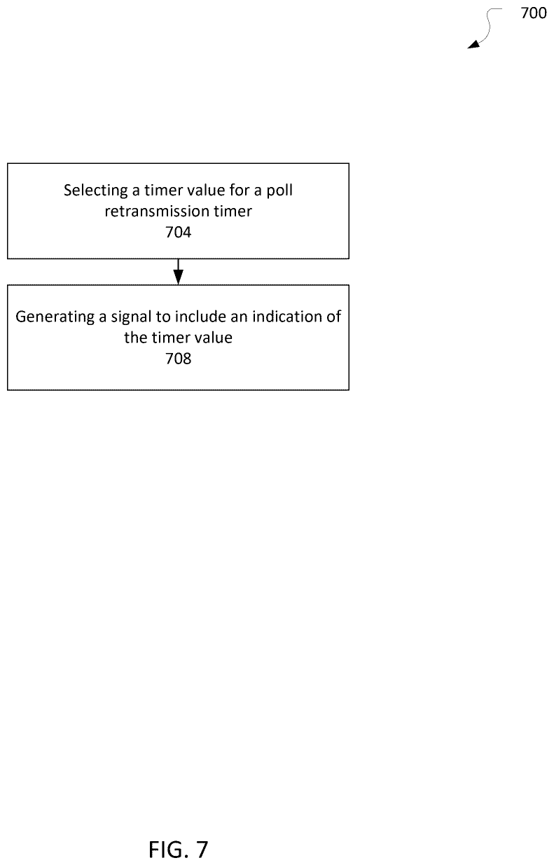

FIG. 7 is an operational flow/algorithmic structure 700 in accordance with some embodiments. The operational flow/algorithmic structure 700 may be performed by a base station such as base station 108, network device 900, or components thereof, for example, processors 904A.

The operational flow/algorithmic structure 700 may include, at 704, selecting a timer value for a poll retransmit timer. In some embodiments, the timer value may be selected based on a network condition. For example, the timer value may be selected based on a loading status of a network (e.g., a RAN), QoS requirements associated with a communication session of a UE, etc.

The operational flow/algorithmic structure 700 may further include, at 708, generating a signal to include an indication of the timer value. The signal may be an RRC signal that provides an indication of the selected timer value in a parameter of an information element.

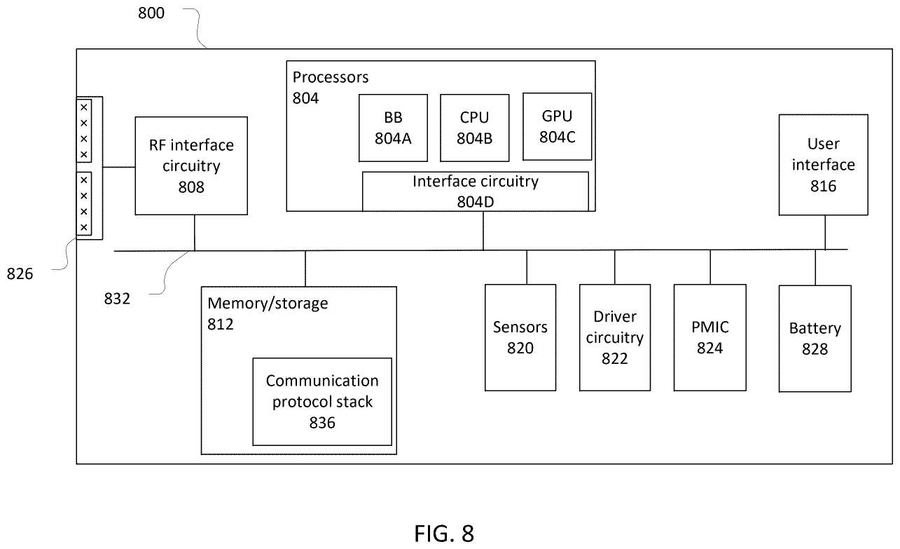

FIG. 8 illustrates a UE 800 in accordance with some embodiments. The UE 800 may be similar to and substantially interchangeable with UE 104.

The UE 800 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 800 may include processors 804, RF interface circuitry 808, memory/storage 812, user interface 816, sensors 820, driver circuitry 822, power management integrated circuit (PMIC) 824, antenna 826, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 832, which may represent any type of interface, input/output, bus (local, system, or expansion), transmission line, trace, or optical connection that allows various circuit components (on common or different chips or chipsets) to interact with one another.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform timer management operations as described herein. The processors 804 may also include interface circuitry 804D to communicatively couple the processor circuitry with one or more other components of the UE 800.

In some embodiments, the baseband processor 804A may access a communication protocol stack 836 in the memory/storage 812 to communicate over a 3GPP compatible network. In general, the baseband processor 804A may access the communication protocol stack 836 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 808.

The baseband processor 804A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 812 may include one or more non-transitory, computer-readable media that includes instructions (for example, communication protocol stack 836) that may be executed by one or more of the processors 804 to cause the UE 800 to manage/control/configure poll retransmit timers as described herein.

The memory/storage 812 includes any type of volatile or non-volatile memory that may be distributed throughout the UE 800. In some embodiments, some of the memory/storage 812 may be located on the processors 804 themselves (for example, memory/storage 812 may be part of a chipset that corresponds to the baseband processor 804A), while other memory/storage 812 is external to the processors 804 but accessible thereto via a memory interface. The memory/storage 812 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 808 may include transceiver circuitry and a radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 826 and proceed to filter and amplify (with a low-noise amplifier) the signal. The signal may be provided to a receiver of the transceiver that down-converts the RF signal into a baseband signal that is provided to the baseband processor of the processors 804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 826.

In various embodiments, the RF interface circuitry 808 may be configured to transmit/receive signals in a manner compatible with NR access technologies.

The antenna 826 may include antenna elements to convert electrical signals into radio waves to travel through the air and to convert received radio waves into electrical signals. The antenna elements may be arranged into one or more antenna panels. The antenna 826 may have antenna panels that are omnidirectional, directional, or a combination thereof to enable beamforming and multiple input, multiple output communications. The antenna 826 may include microstrip antennas, printed antennas fabricated on the surface of one or more printed circuit boards, patch antennas, or phased array antennas. The antenna 826 may have one or more panels designed for specific frequency bands including bands in FR1 or FR2.

The user interface 816 includes various input/output (I/O) devices designed to enable user interaction with the UE 800. The user interface 816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 800.

The sensors 820 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various input/output (I/O) devices that may be present within, or connected to, the UE 800. For example, driver circuitry 822 may include a display driver to control and allow access to a display device, a touchscreen driver to control and allow access to a touchscreen interface, sensor drivers to obtain sensor readings of sensors 820 and control and allow access to sensors 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage power provided to various components of the UE 800. In particular, with respect to the processors 804, the PMIC 824 may control power-source selection, voltage scaling, battery charging, or DC-to-DC conversion.

A battery 828 may power the UE 800, although in some examples the UE 800 may be mounted deployed in a fixed location and may have a power supply coupled to an electrical grid. The battery 828 may be a lithium ion battery, a metal-air battery, such as a zinc-air battery, an aluminum-air battery, a lithium-air battery, and the like. In some implementations, such as in vehicle-based applications, the battery 828 may be a typical lead-acid automotive battery.

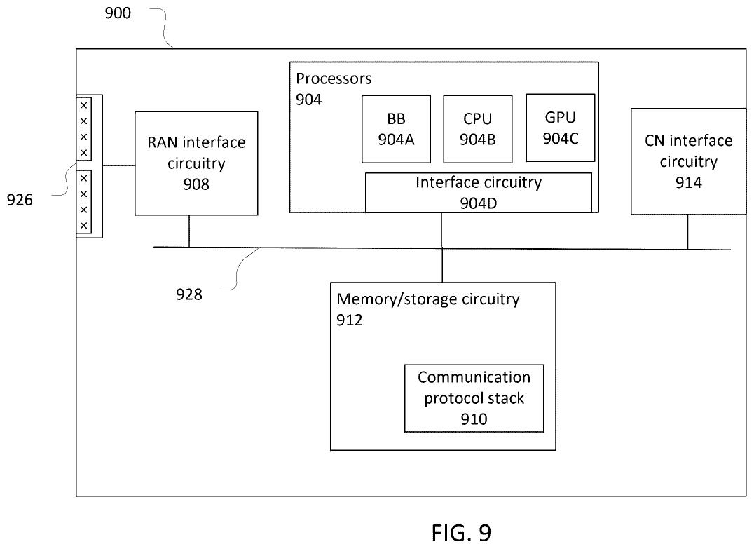

FIG. 9 illustrates a network device 900 in accordance with some embodiments. The network device 900 may be similar to, and substantially interchangeable with, the base station 108.

The network device 900 may include processors 904, RF interface circuitry 908 (if implemented as a base station), core network (CN) interface circuitry 914, memory/storage circuitry 912, and antenna structure 926.

The components of the network device 900 may be coupled with various other components over one or more interconnects 928.

The processors 904, RF interface circuitry 908, memory/storage circuitry 912 (including communication protocol stack 910), antenna structure 926, and interconnects 928 may be similar to like-named elements shown and described with respect to FIG. 8.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage circuitry 912 to cause the network device 900 to manage/control/configure poll retransmit timers as described herein. The processors 904 may also include interface circuitry 904D to communicatively couple the processor circuitry with one or more other components of the network device 900.

The CN interface circuitry 914 may provide connectivity to a core network, for example, a 5th Generation Core network (5GC) using a 5GC-compatible network interface protocol such as carrier Ethernet protocols, or some other suitable protocol. Network connectivity may be provided to/from the network device 900 via a fiber optic or wireless backhaul. The CN interface circuitry 914 may include one or more dedicated processors or

FPGAs to communicate using one or more of the aforementioned protocols. In some implementations, the CN interface circuitry 914 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method comprising: detecting a poll trigger event associated with an acknowledgement mode transmission; determining whether one or more conditions are satisfied; selecting, based on said determining whether the one or more conditions are satisfied, a timer value; submitting, based on said detecting the poll trigger event, an data unit with a polling bit to a lower layer for transmission; and starting, based on said submitting the data unit with the polling bit to the lower layer, a timer with the timer value.

Example 2 includes the method of example 1 or some other example herein, wherein selecting the timer value comprises:

selecting, based on said determining whether the one or more conditions are satisfied, the timer value from a plurality of timer values.

Example 3 includes the method of example 1 or some other example herein, determining whether the one or more conditions are satisfied comprises determining the one or more conditions are satisfied and selecting the timer value comprises: selecting, based on said determining the one or more conditions are satisfied, an adjustment parameter; and applying the adjustment parameter to a default timer value to obtain the timer value.

Example 4 includes the method of example 1 or some other example herein, wherein the timer is a poll retransmit timer.

Example 5 includes the method of example 1 or some other example herein, wherein determining whether the one or more conditions are satisfied comprises: identifying a packet in a transmission buffer that is: a delay-critical packet that has a remaining time till expiry of a discard timer less than a remaining time threshold; or an important packet with an importance level greater than a predetermined importance threshold.

Example 6 includes the method of example 5 or some other example herein, wherein determining whether the one or more conditions are satisfied comprises: determining whether a number of delay-critical packets or important packets in the transmission buffer exceeds a predetermined threshold number.

Example 7 includes the method of example 1 or some other example herein, wherein determining whether the one or more conditions are satisfied comprises: determining whether a number of AMD PDUs corresponding to delay-critical or important radio link control (RLC) service data units (SDUs) sent since a most recent poll bit was transmitted exceeds a predetermined threshold number of packets.

Example 8 includes the method of example 1 or some other example herein, wherein determining whether the one or more conditions are satisfied comprises: determining whether a data volume of acknowledgment mode data (AMD) protocol data units (PDUs) corresponding to delay-critical or important radio link control (RLC) service data units (SDUs) sent since a last status report was received exceeds a predetermined threshold data volume.

Example 9 includes the method of example 1 or some other example herein, wherein determining whether the one or more conditions are satisfied comprises: determining whether a number of acknowledgment mode data (AMD) protocol data units (PDUs) sent since a last transmission of an AMD PDU corresponding to a delay-critical packet or important radio link control (RLC) service data unit (SDUs) or segment exceeds a predetermined threshold number.

Example 10 includes the method of example 1 or some other example herein, wherein determining whether the one or more conditions are satisfied comprises: determining whether a data volume of acknowledgment mode data (AMD) protocol data units (PDUs) sent since a last transmission of an AMD PDU corresponding to a delay-critical or important radio link control (RLC) service data unit (SDU) or segment exceeds a predetermined threshold data volume.

Example 11 includes the method of example 1 or some other example herein, wherein the one or more conditions are associated with a protocol data unit (PDU) set importance, a PDU set size, a number of PDUs in a PDU set, or whether an end PDU of a PDU set has arrived.

Example 12 includes a method comprising: detecting a poll trigger event associated with an acknowledgement mode transmission; determining whether one or more conditions are satisfied; selecting, based on said determining whether the one or more conditions are satisfied, a timer; submitting, based on said detecting the poll trigger event, a data unit with a polling bit to a lower layer for transmission; and starting, based on said submitting the data unit with the polling bit to the lower layer, the timer.

Example 13 includes the method of example 12 or some other example herein, wherein selecting the timer comprises: selecting, based on said determining whether the one or more conditions are satisfied, the timer from a plurality of timers.

Example 14 includes the method of example 12 or some other example herein, wherein the timer is a poll retransmit timer.

Example 15 includes the method of example 12 or some other example herein, wherein determining whether the one or more conditions are satisfied comprises: identifying a packet in a transmission buffer that is: a delay-critical packet that has a remaining time till expiry of a discard timer less than a remaining time threshold; or an important packet that is associated with an importance level greater than a predetermined importance threshold.

Example 16 includes the method of example 15 or some other example herein, wherein determining whether the one or more conditions are satisfied comprises: determining whether a number of delay-critical packets or important packets in the transmission buffer exceeds a predetermined threshold number.

Example 17 includes the method of example 12 or some other example herein, wherein determining whether the one or more conditions are satisfied comprises: determining whether a number of acknowledgment mode data (AMD) protocol data units (PDUs) corresponding to delay-critical or important radio link control (RLC) service data units (SDUs) sent since a most recent poll bit was transmitted exceeds a predetermined threshold number of packets.

Example 18 includes the method of example 12 or some other example herein, wherein determining whether the one or more conditions are satisfied comprises: determining whether a data volume of acknowledgment mode data (AMD) protocol data units (PDUs) corresponding to delay-critical or important radio link control (RLC) service data units (SDUs) sent since a last status report was received exceeds a predetermined threshold data volume.

Example 19 includes the method of example 12 or some other example herein, wherein determining whether the one or more conditions are satisfied comprises: determining whether a number of acknowledgment mode data (AMD) protocol data units (PDUs) sent since a last transmission of an AMD PDU corresponding to a delay-critical packets or important RLC SDU or segment exceeds a predetermined threshold number.

Example 20 includes the method of example 12 or some other example herein, wherein determining whether the one or more conditions are satisfied comprises: determining whether a data volume of acknowledgment mode data (AMD) protocol data units (PDUs) sent since a last transmission of an AMD PDU corresponding to a delay-critical packets or important RLC SDU or segment exceeds a predetermined threshold data volume.

Example 21 includes the method of example 12 or some other example herein, wherein the one or more conditions are associated with a protocol data unit (PDU) set importance, a PDU set size, a number of PDUs in a PDU set, or whether an end PDU of a PDU set has arrived.

Example 22 includes a method comprising: detecting a polling trigger associated with an acknowledgement mode (AM) transmission; submitting, based on said detecting the polling trigger, a data unit with a polling bit to a lower layer for transmission; starting, based on said submitting the data unit with the polling bit to the lower layer, a timer; determining one or more conditions are satisfied; and stopping the timer based on said determining the one or more conditions are satisfied.

Example 23 includes the method of example 22 or some other example herein, wherein the timer is a poll retransmit timer.

Example 24 includes the method of example 22 or some other example herein, wherein determining whether the one or more conditions are satisfied comprises: identifying a packet in a transmission buffer that is: a delay-critical packet that has a remaining time till expiry of a discard timer less than a remaining time threshold; or an important packet that is associated with an importance level greater than a predetermined importance threshold.

Example 25 includes the method of example 24 or some other example herein, wherein determining whether the one or more conditions are satisfied comprises: determining whether a number of delay-critical packets or important packets in the transmission buffer exceeds a predetermined threshold number.

Example 26 includes the method of example 22 or some other example herein, wherein determining whether the one or more conditions are satisfied comprises: determining whether a number of acknowledgment mode data (AMD) protocol data units (PDUs) corresponding to delay-critical or important radio link control (RLC) service data units (SDUs) sent since a last status report was received exceeds a predetermined threshold number of packets.

Example 27 includes the method of example 22 or some other example herein, wherein determining whether the one or more conditions are satisfied comprises: determining whether a data volume of acknowledgment mode data (AMD) protocol data units (PDUs) corresponding to delay-critical or important radio link control (RLC) service data units (SDUs) sent since a last status report was received exceeds a predetermined threshold data volume.

Example 28 includes the method of example 22 or some other example herein, wherein determining whether the one or more conditions are satisfied comprises: determining whether a number of acknowledgment mode data (AMD) protocol data units (PDUs) sent since a last transmission of an AMD PDU corresponding to a delay-critical packet or important radio link control (RLC) service data unit (SDUs) or segment exceeds a predetermined threshold number.

Example 29 includes the method of example 22 or some other example herein, wherein determining whether the one or more conditions are satisfied comprises: determining whether a data volume of acknowledgment mode data (AMD) protocol data units (PDUs) sent since a last transmission of an AMD PDU corresponding to a delay-critical or important radio link control (RLC) service data unit (SDU) or segment exceeds a predetermined threshold data volume.

Example 30 includes the method of example 22 or some other example herein, wherein the one or more conditions are associated with a protocol data unit (PDU) set importance, a PDU set size, a number of PDUs in a PDU set, or whether an end PDU of a PDU set has arrived.

Example 31 includes a method comprising: selecting a timer value for a poll retransmit timer; and generating a signal to include an indication of the timer value, the signal to be transmitted to a user equipment (UE).

Example 31 includes the method of example 31 or some other example herein, wherein the timer value is less than a default timer value associated with the poll retransmit timer.

Example 31 includes the method of example 31 or some other example herein, further comprising: detecting a condition of a network; and selecting the timer value based on detecting the condition of the network.

Example 34 includes the method of example 33 or some other example herein, wherein detecting the condition of the network comprises: detecting a loading status of the network; or detecting a quality of service requirement associated with a communication session of the UE.

Another example may include an apparatus comprising means to perform one or more elements of a method described in or related to any of examples 1-34, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-34, or any other method or process described herein.

Another example may include an apparatus comprising logic, modules, or circuitry to perform one or more elements of a method described in or related to any of examples 1-34, or any other method or process described herein.

Another example may include a method, technique, or process as described in or related to any of examples 1-34, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-34, or portions thereof.

Another example may include a signal as described in or related to any of examples 1-34, or portions or parts thereof.

Another example may include a datagram, information element, packet, frame, segment, PDU, or message as described in or related to any of examples 1-34, or portions or parts thereof, or otherwise described in the present disclosure.

Another example may include a signal encoded with data as described in or related to any of examples 1-34, or portions or parts thereof, or otherwise described in the present disclosure.

Another example may include a signal encoded with a datagram, IE, packet, frame, segment, PDU, or message as described in or related to any of examples 1-34, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-34, or portions thereof.

Another example may include a computer program comprising instructions, wherein execution of the program by a processing element is to cause the processing element to carry out the method, techniques, or process as described in or related to any of examples 1-34, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
detecting a poll trigger event associated with an acknowledgement mode transmission;
determining whether one or more conditions are satisfied;
selecting, based on said determining whether the one or more conditions are satisfied, a timer value;
submitting, based on said detecting the poll trigger event, an data unit with a polling bit to a lower layer for transmission; and
starting, based on said submitting the data unit with the polling bit to the lower layer, a timer with the timer value.

2. The method of claim 1, wherein selecting the timer value comprises:
selecting, based on said determining whether the one or more conditions are satisfied, the timer value from a plurality of timer values.

3. The method of claim 1, determining whether the one or more conditions are satisfied comprises determining the one or more conditions are satisfied and selecting the timer value comprises:
selecting, based on said determining the one or more conditions are satisfied, an adjustment parameter; and
applying the adjustment parameter to a default timer value to obtain the timer value.

4. The method of claim 1, wherein the timer is a poll retransmit timer.

5. The method of claim 1, wherein determining whether the one or more conditions are satisfied comprises:
identifying a packet in a transmission buffer that is: a delay-critical packet that has a remaining time till expiry of a discard timer less than a remaining time threshold; or an important packet with an importance level greater than a predetermined importance threshold.

6. The method of claim 1, wherein determining whether the one or more conditions are satisfied comprises:
determining whether a number of AMD PDUs corresponding to delay-critical or important radio link control (RLC) service data units (SDUs) sent since a most recent poll bit was transmitted exceeds a predetermined threshold number of packets.

7. The method of claim 1, wherein determining whether the one or more conditions are satisfied comprises:
determining whether a data volume of acknowledgment mode data (AMD) protocol data units (PDUs) corresponding to delay-critical or important radio link control (RLC) service data units (SDUs) sent since a last status report was received exceeds a predetermined threshold data volume.

8. The method of claim 1, wherein determining whether the one or more conditions are satisfied comprises:
determining whether a number of acknowledgment mode data (AMD) protocol data units (PDUs) sent since a last transmission of an AMD PDU corresponding to a delay-critical packet or important radio link control (RLC) service data unit (SDUs) or segment exceeds a predetermined threshold number.

9. The method of claim 1, wherein determining whether the one or more conditions are satisfied comprises:
determining whether a data volume of acknowledgment mode data (AMD) protocol data units (PDUs) sent since a last transmission of an AMD PDU corresponding to a delay-critical or important radio link control (RLC) service data unit (SDU) or segment exceeds a predetermined threshold data volume.

10. One or more non-transitory, computer-readable media having instructions that, when executed, cause circuitry to:
detect a poll trigger event associated with an acknowledgement mode transmission;
determine whether one or more conditions are satisfied;
select, based on determination of whether the one or more conditions are satisfied, a timer;
submit, based on detection of the poll trigger event, a data unit with a polling bit to a lower layer for transmission; and
start, based on submission of the data unit with the polling bit to the lower layer, the timer.

11. The one or more non-transitory, computer-readable media of claim 10, wherein to select the timer the circuitry is to:
select, based on determination of whether the one or more conditions are satisfied, the timer from a plurality of timers.

12. The one or more non-transitory, computer-readable media of claim 10, wherein to determine whether the one or more conditions are satisfied the circuitry is to:
identify a packet in a transmission buffer that is: a delay-critical packet that has a remaining time till expiry of a discard timer less than a remaining time threshold; or an important packet that is associated with an importance level greater than a predetermined importance threshold.

13. The one or more non-transitory, computer-readable media of claim 10, wherein to determine whether the one or more conditions are satisfied the circuitry is to:
determine whether a number of acknowledgment mode data (AMD) protocol data units (PDUs) corresponding to delay-critical or important radio link control (RLC) service data units (SDUs) sent since a most recent poll bit was transmitted exceeds a predetermined threshold number of packets.

14. The one or more non-transitory, computer-readable media of claim 10, wherein to determine whether the one or more conditions are satisfied the circuitry is to:
determine whether a data volume of acknowledgment mode data (AMD) protocol data units (PDUs) corresponding to delay-critical or important radio link control (RLC) service data units (SDUs) sent since a last status report was received exceeds a predetermined threshold data volume.

15. The one or more non-transitory, computer-readable media of claim 10, wherein to determine whether the one or more conditions are satisfied the circuitry is to:
determine whether a number of acknowledgment mode data (AMD) protocol data units (PDUs) sent since a last transmission of an AMD PDU corresponding to a delay-critical packets or important RLC SDU or segment exceeds a predetermined threshold number.

16. The one or more non-transitory, computer-readable media of claim 10, wherein to determine whether the one or more conditions are satisfied the circuitry is to:
determine whether a data volume of acknowledgment mode data (AMD) protocol data units (PDUs) sent since a last transmission of an AMD PDU corresponding to a delay-critical packets or important RLC SDU or segment exceeds a predetermined threshold data volume.

17. The one or more non-transitory, computer-readable media of claim 10, wherein the one or more conditions are associated with a protocol data unit (PDU) set importance, a PDU set size, a number of PDUs in a PDU set, or whether an end PDU of a PDU set has arrived.

18. A method comprising:
selecting a timer value for a poll retransmit timer; and
generating a signal to include an indication of the timer value, the signal to be transmitted to a user equipment (UE).

19. The method of claim 18, wherein the timer value is less than a default timer value associated with the poll retransmit timer.

20. The method of claim 18, further comprising:
detecting a condition of a network; and
selecting the timer value based on detecting the condition of the network.
